(19) United States
(12) Patent Application Publication
(10) Pub. No.: US 2016/0314198 A1
(43) Pub. Date: Oct. 27, 2016

(54) DATA RESOLUTION WITHIN SEARCH RESULTS FROM A HIERARCHICALLY ASSOCIATED DATABASE

(71) Applicant: INFOTRAX SYSTEMS, Orem, UT (US)

(72) Inventors: Larry Nash, Provo, UT (US); Dan Floyd, West Jordan, UT (US); Mark Rawlins, Lehi, UT (US); Devry Anderson, Pleasant Grove, UT (US)

(21) Appl. No.: 15/071,045

(22) Filed: Mar. 15, 2016

Related U.S. Application Data
(60) Provisional application No. 62/133,707, filed on Mar. 16, 2015.

(51) Int. Cl. G06F 17/30

(52) U.S. Cl. CPC G06F 17/30699; G06F 17/30719

(57) ABSTRACT

A computerized method for multi-level data resolution based upon searches of the hierarchically organized elements comprises receiving a database query directed towards returning information from one or more locations within a hierarchically organized data structure. The method can also comprise generating a summary of the information that conforms with the query and a first filter condition. Additionally, the method can comprise receiving a request for a detailed view of the information in the summary. Upon receiving the request the method can include generating a detailed accounting of the information that conforms with the query and a second filter condition. Additionally, the second filter condition can be different from the first filter condition.

### CROSS-REFERENCE TO RELATED APPLICATIONS

This application claims the benefit of and priority to, U.S. Provisional Application Ser. No. 62/133,707, filed on Mar. 16, 2015, entitled “DATA RESOLUTION WITHIN SEARCH RESULTS FROM A HIERARCHICALLY ASSOCIATED DATABASE”. All of the aforementioned applications are incorporated by reference herein in their entirety.

### BACKGROUND OF THE INVENTION

1. Technical Field

The present invention relates generally to the technical characteristics and processing of a digital data structure.

2. Background and Relevant Art

Many businesses store hierarchically organized data in databases where any entry (or row) may be the parent of one or more child entries (or rows) within the database. A typical hierarchically organized database stores data in a relational database table. Although standard relational database access techniques can be used to access and process hierarchical data stored in this manner, these techniques can be slow especially when the hierarchical structure is large.

These slower techniques that have been used for accessing and processing hierarchical data have limited the number and type of real-time applications that consume the hierarchical data. In one conventional example, multi-level marketing (“MLM”) companies maintain hierarchical data structures representing the hierarchy of individuals participating in the multi-level marketing scheme.

A conventional hierarchical database will store many different pieces of data for each individual such as the total amount of sales for the individual in a specified period, a number of new customers obtained in a specified period, etc. One common computation performed on the hierarchical data is the calculation of commissions based on the total amount of sales for each individual. One individual's commission is generally based not only on the individual's sales, but the sales of other individuals under the individual in the hierarchy. In a large hierarchy, it may take a relatively long time to calculate the commission, or to calculate another figure that is dependent on the hierarchical relationships, for an individual.

Many businesses and organizations desire to give employees and contractors access to certain portions of the data stored within the hierarchy. For example, a MLM company may wish to give a particular salesperson access to their own sales information, along with the sales information of individuals that the particular salesperson enrolled, which would appear below the particular salesperson in the hierarchy. In some of these cases, however, the MLM company may wish to limit the particular salesperson's access to only the sales data of others, and not allow the particular salesperson to access personal information that is stored within the hierarchy.

Accordingly, there are a number of disadvantages in the art that can be addressed.

### BRIEF SUMMARY OF THE INVENTION

The present invention extends to methods, systems, and computer program products for multi-level data resolution based upon searches of the hierarchically organized elements. In particular, implementations of the present invention allow a user to access a summary of information stored within a hierarchical data structure and then to access a detailed accounting of at least a portion of the information in the summary. Additionally, implementations allow an administrator to create permissions that allow some information to be accessible in a summary form, while preventing some of the same information from being available in a detailed accounting form.

In at least one implementation, a computerized method for multi-level data resolution based upon searches of the hierarchically organized elements comprises receiving a database query directed towards returning information from one or more locations within a hierarchically organized data structure. The method can also comprise generating a summary of the information that conforms with the query and a first filter condition. Additionally, the method can comprise receiving a request for a detailed view of the information in the summary. Upon receiving the request the method can include generating a detailed accounting of the information that conforms with the query and a second filter condition. The second filter condition can be different from the first filter condition.

Additionally, another implementation of a method can include identifying a query of interest that is directed towards returning a summary of information gathered from multiple entries within a hierarchically organized data structure. The method can then include transmitting the query of interest to a database system. Additionally, the method can include receiving a summary of the information that conforms with the query of interest. Next, the method can include transmitting a request for a detailed accounting of at least a portion of the information in the summary. Further the method can include receiving a detailed accounting of at least the portion of the information that conforms with the query of interest.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary computer environment in which the present invention may be implemented;

FIG. 2 illustrates exemplary hierarchically organized data and an exemplary ordered flat file derived from the data;

FIG. 3 depicts the hierarchically organized data from FIG. 2;

FIG. 4A depicts an embodiment of results of a query requesting data;

FIG. 4B depicts a detailed accounting of the information summarized in FIG. 4A;

FIG. 5 is a flowchart of another exemplary method implemented by one or more embodiments of the invention; and

FIG. 6 is a flowchart of another exemplary method implemented by one or more embodiments of the invention.

### DETAILED DESCRIPTION OF THE PREFERRED EMBODIMENTS

The present invention extends to methods, systems, and computer program products for multi-level data resolution based upon searches of the hierarchically organized elements. In particular, implementations of the present invention allow a user to access a summary of information stored within a hierarchical data structure and then to access a detailed accounting of at least a portion of the information in the summary. Additionally, implementations allow an administrator to create permissions that allow some information to be accessible in a summary form, while preventing some of the same information from being available in a detailed accounting form.

Accordingly, one or more implementations of the present invention allow a user to request information in a summary form, using a first set of permissions, and to also request information in a detailed accounting, using a second set of permissions. For example, a user can request information that summarizes data stored throughout an entire hierarchically organized data structure. When the user requests a detailed accounting of the summarized information, however, a second set of permission might be applied to the detailed accounting that prevents at least a portion of the information originally included in the summary from being displayed in a detailed accounting. Accordingly, in at least one implementation, an administrator can allow users to receive a general summary of organization wide information, while at the same time limiting the scope of the user's access to detailed information about the organization.

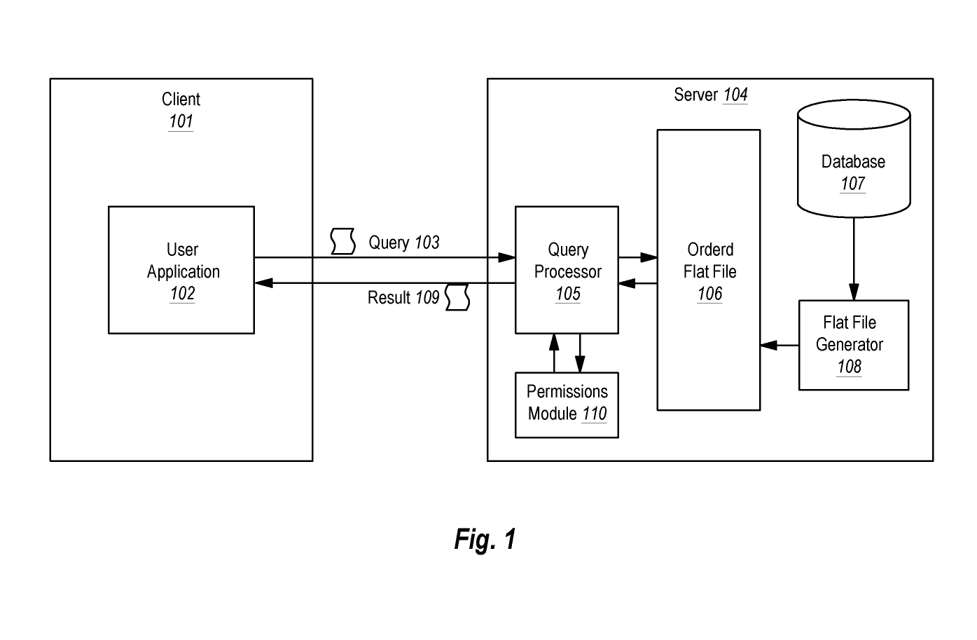

For example, FIG. 1 illustrates a generalized computer environment including a client 101 and a server 104 according to embodiments of the present invention. Client 101 may be any computer including a desktop, laptop, smart phone, etc. User application 102 on client 101 is an application that sends queries to server 104 for viewing hierarchical data stored in database 107. For example, user application 102 may be a general-purpose web browser, or may be a dedicated local or web-based application.

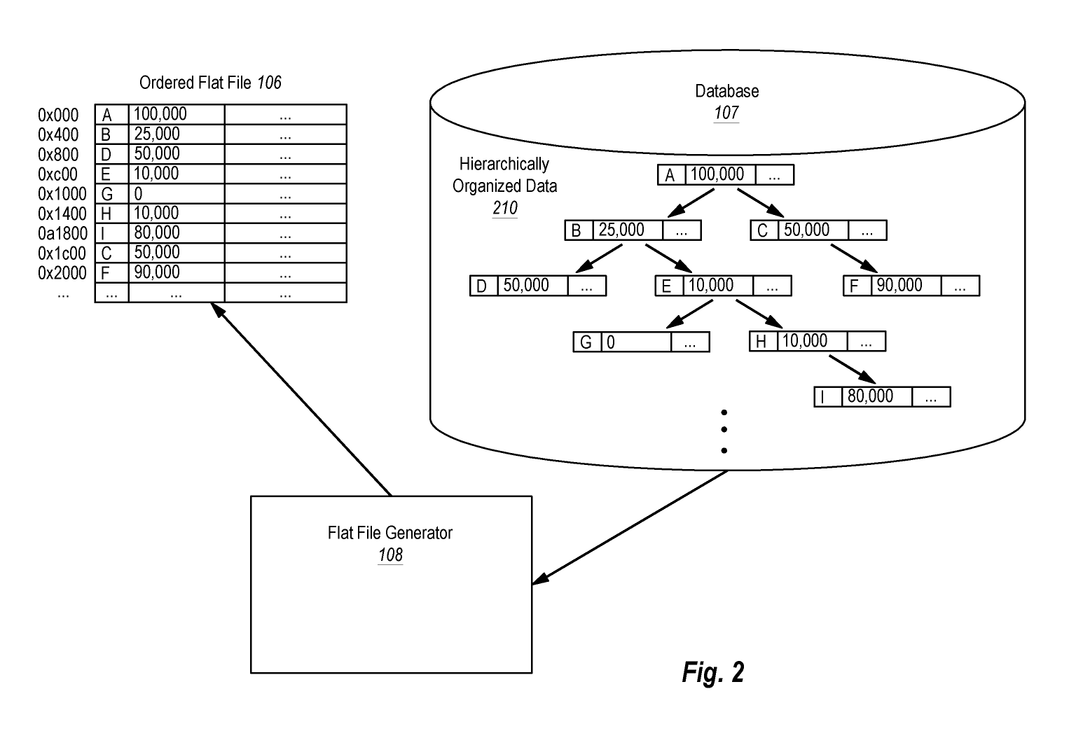

To expedite the processing of such queries, at least one implementation of the present invention involves use of a flat file generator 108 on server 104 to create and maintain an ordered flat file 106. The ordered flat file 106 stores at least some of the hierarchical data of the database 107 as a flat file that maintains the hierarchical organization of the data as will be further described below with reference to FIG. 2. When a query is received from user application 102, the query processor 105 on server 104 accesses the permissions module 110 to determine what permissions should be applied to the query. The query processor 105 then accesses the permitted data fields and entries within the ordered flat file 106 to resolve the query rather than accessing the underlying data in database 107. In some implementations, after initially creating the flat file 106, the hierarchical data in the database 107 can be deleted.

FIG. 2 depicts a database 107, which stores exemplary hierarchically organized data 210. The hierarchically organized data 210 comprises a plurality of elements that each has at least one parent child relationship with another element. FIG. 2 also illustrates an exemplary ordered flat file 106 created from the hierarchically organized data 210 by flat file generator 108. Hierarchically organized data 210 is shown as a tree structure for ease of illustration; however, an ordered flat file can be created from an underlying database of any type or format (e.g., relational, flat file, etc.). The ordered flat file 106 is organized such that all direct descendants of an element are listed directly below the element within the flat file. For example, because Element A is the base node and all other elements are descendants of Element A, it is listed first in the ordered flat file.

Next, Element B is listed with all its direct descendants listed directly below it and prior to any other element that is at the same level or a higher level in the hierarchy than Element B. For example, Element C (which is at the same level as Element B (i.e., a brother of Element B)) is listed after all of Element B's direct descendants (Elements D, E, G, H, and I).

As depicted in FIG. 2, the various elements (A, B, D, E, . . . ) are depicted as being directly adjacent to each other in memory. In at least one implementation, however, the elements are not necessarily next to each other in memory. Instead, the various elements can be linked in the same order depicted in the ordered flat file 106 using pointers. For example, Element B can include a pointer to the memory location of Element D and Element A. Accordingly, Element B could identify that Element A is directly above it in the ordered flat file 106 and that Element D is directly below it.

In this way, any element's descendants can be quickly determined by reading the ordered flat file 106 until an element with the same or higher level in the hierarchy is reached. For example, it can quickly be determined that Element I does not have any descendants because the next element below Element I in the ordered flat file 106 is Element C, which is a brother to Element B, and is three levels higher than Element I in the hierarchy.

In at least one implementation, each element within the ordered flat file can comprise a field that indicates the element's hierarchical parent. For example, element C can comprise a field that indicates that Element A is Element C′s parent. As such, when traversing the ordered flat file from Element I to Element C, it can be determined that Element C is not a child of Element I, because Element C comprises an indication its parent is Element A.

The listed fields in the ordered flat file 106 of FIG. 2 represent the element's name (or identifier) and a total sales amount for the person represented by the element. However, an ordered flat file can include any number of fields storing any type of data as indicated by the ellipses. For example, FIG. 2 illustrates an implementation in which each element in the ordered flat file 106 includes a field that defines the element's level in the hierarchy, or that may indicate a person's (represented by the element) title, rank, or position in a company structure, as well as other fields containing data that may be used to calculate reports. The ordered flat file 106 of FIG. 2 depicts elements that are 1 KB in size as represented by the hexadecimal addresses to the left of each element. However, any size may be allocated to elements in the hierarchy, and each element may in fact be a different size. One will appreciate that, in at least one embodiment, each element is the same size.

An ordered flat file can be particularly beneficial in representing a “downline” of an individual in a hierarchical organization, such as a multi-level marketing business structure. An individual's downline in a multi-level marketing hierarchy refers to the individual and all other individuals that fall below the individual in the hierarchy. Using the example of FIG. 1, Element B's downline would include Elements D, E, G, H, and I (but not C, F). As can be seen, this downline can quickly be determined by sequentially reading the ordered flat file from Element B to Element I and stopping before Elements C and F.

Generally, it is faster to access hierarchical data stored in an ordered flat file than it is to access the same data stored in an underlying database. Therefore, calculations based on hierarchical data, such as commissions as previously described, can be performed more quickly by creating an ordered flat file of the hierarchical data, and accessing the hierarchical data within the ordered flat file to generate the required result set.

An ordered flat file may be created from a hierarchical dataset stored in an underlying database at various times. For example, a multi-level marketing business may update its database with sales figures at the end of each business day. After the updates are entered each day, a complete ordered flat file may be generated to represent the state of the hierarchical data after the updates for that day are entered. Of course, an ordered flat file may be created at any interval. Additionally, in at least one embodiment, an existing flat file can be updated to reflect new information by individually accessing and updating each required data field. For example, a new element could be added to an ordered flat file 106 by updating one or more pointers to include the new element at the correct location within the file.

Generally, a query for data of a hierarchical dataset requests a sub-portion of the hierarchical dataset. One example includes a query for an individual's downline. As described above, the sub-portion of hierarchical data can be obtained by reading a portion of the ordered flat file. To locate the beginning of the sequential portion to be read, a starting element must be identified. For example, to locate the beginning of Element B's downline, Element B must be identified in the ordered flat file.

At least two approaches can be taken to locate the beginning of the sequential portion: sequential and random access. Sequential access refers to reading from the beginning of the ordered flat file, and continuing to read the elements in the ordered flat file until the first element of the sequential portion is identified. Once the first element is identified, any permissions (i.e., filtering conditions) in the query can be applied to the elements in the portion as the elements are read.

Random access, on the other hand, refers to reading an element of the ordered flat file without first reading the preceding elements in the ordered flat file. Random access can be accomplished by maintaining a location index for each element in the ordered flat file. Reading the element's location within the index and then accessing the ordered flat file at the address provided by the index can determine an element's location in the ordered flat file. In at least one implementation, the index and/or the flat file can be addressed using a hash map.

In either sequential or random access, once the first element of the sequential portion is identified, the remaining elements of the sequential portion can quickly be retrieved by sequentially reading the ordered flat file until an element that is at the same or higher level in the hierarchy is identified at which point no further reads need to be performed. As each element in the sequential portion is read, the filtering criteria can be applied to generate one or more result sets. In other words, in at least one implementation, only a single pass of the ordered flat file is required to identify the relevant portion and to apply the permissions to the portion to generate one or more result sets.

As described above, implementations of the present invention provide methods and systems for quickly accessing data elements from within hierarchical tree structures. In addition to the ability to quickly access the data element, in at least one implementation, various permissions or filters can be applied to the query results. In particular, one or more administrators can create rules that determine what information a given user can access and retrieve from within the database.

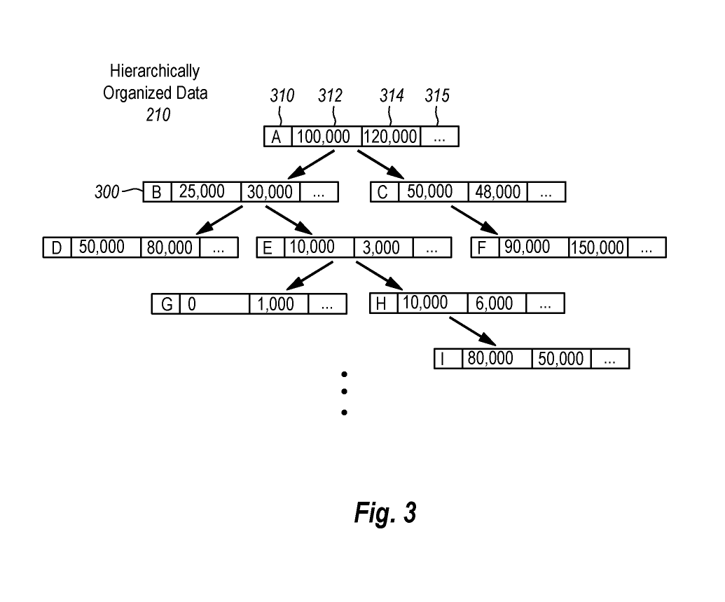

For example, FIG. 3 depicts the hierarchically organized data 210 from FIG. 2. The depicted hierarchically organized data 210 includes an identification field 310, which identifies a particular salesperson, a current sales amount field 312, which indicates the amount of money the associated salesperson generated for a current time period, and a previous sales amount field 314, which indicates the amount of money the associated salesperson generated for a previous time period. As depicted, each of the aforementioned fields are indicated with respect to entry A, however, one will understand that this is just for clarity purposes and that each of the referenced fields are also present within the other entries. An “entry” refers to a data element, or node, within the hierarchically organized data 210. Additionally, one will understand that the depicted fields are only presented for the sake of illustration, and that additional or alternative fields 315 can be present within a given hierarchically organized data structure 210.

In at least one implementation, various users may access information within the ordered flat file 210. In particular, one or more salespersons, who may be included as entries within the ordered flat file 210, can access information relating to their own records, and, in some cases, information from the records of other salespersons. For example, in a typical large sales company (e.g., an MLM), a salesperson can enroll additional salespersons below them in the company hierarchy. The salesperson can then receive a commission based upon the sales that were made by the enrollees below the salesperson in the hierarchy. Accordingly, one will understand why a salesperson may desire to access information relating to the performance of his or her enrollees.

One will also understand, however, that the company may desire or be obligated to protect certain personal information that may be stored within the ordered flat file 106 from being accessed by anyone other than designated company officers. Additionally, in massive organizations, with accompanying massive hierarchically organized data structures 210 and massive ordered flat files 106, it may be desirable to automatically generate summaries of data for salespersons, while providing options for detailed accountings of the summarized data.

In at least one implementation, a user can access certain information on a summary level, but not on a detailed accounting level. For example, a salesperson may be able to access a summary of the total sales amount for the entire company, but may be prohibited from accessing a detailed accounting about every individual salesperson's contribution to the company's total. In some cases, however, it may be desirable to allow the salesperson to access a detailed accounting of at least a portion of the hierarchically organized data 210. For instance, the salesperson may be able to access a detailed accounting of his or her downline, but be prevented from accessing a detailed accounting of information outside of his or her downline. Further, in at least one implementation, a salesperson may be prevented from accessing a detailed accounting of certain data fields within his or her downline.

For example, a salesperson may only be able to access a detailed accounting of data fields within a certain number of levels down his or her downline. This may be useful in preventing a salesperson from accessing information relating to other salespeople that are relationally distant from the salesperson. In contrast, in at least one implementation, a salesperson may be allowed to access a detailed accounting of specific data fields outside of the salesperson's downline.

As used within this application, a summary of information can include cumulative data, anonymous data, and/or some other form of data lending towards an overview. In contrast, a detailed accounting of information can include at least a portion of the individual data points that were considered when generating the summary. Additionally, in at least one implementation, a detailed accounting includes identification information associated with one or more of the data points. For example, the summary of information may be a figure representative of information from various portions of the entire hierarchically organized data structure 210. The detailed accounting, on the other hand, may comprise the individual entry records that were used in calculating the summary of the information.

In some implementations, various companies may desire to provide all personnel (e.g., all salespersons) access to certain cumulative information gathered from the entire ordered flat file 106, possibly including information outside of the salespersons downlines. For example, an MLM company may provide all salespersons access to information relating to the current total company sales, the sales amount of the highest achieving salesperson, the salesperson with the highest number of enrollees, etc. Similarly, an MLM company may desire to provide individuals with information relating to previously measured time periods. For example, the MLM company may desire to provide salespersons information comparing year-over-year performance.

In order to generate this and similar information, a salesperson may need access to information stored throughout the entire ordered flat file 106. Similarly, one will understand that an MLM company may desire to allow a salesperson to gather instantly updated information relating to the above mentioned categories from the ordered flat file 106, while at the same time protecting specific information from being accessed.

Accordingly, in at least one implementation, the query processor 105 can receive a query directed towards returning a summary of a particular data field within the hierarchically organized data 210. Upon receiving the query, the query processor 105 can receive from the permissions module 110 a first permission (i.e., a first filter) that is configured to filter the queried data. The first filter can be configured to only allow a query result that is a summary of multiple fields. In other words, the first filter can allow a cumulated result from multiple individual fields to be generated, while preventing any individual data from being presented to the user.

Additionally, in at least one implementation, a query can comprise multiple sub-queries. For example, a user may generate a query that is directed towards returning information from multiple distinct data fields and/or categories. For instance, a user may create a query that is directed towards returning an ordered list of salespeople based upon individual sales volume and a summary of total gross sales. In at least one implementation, a single pass of the ordered flat file 106 can generate the results for both of these queries.

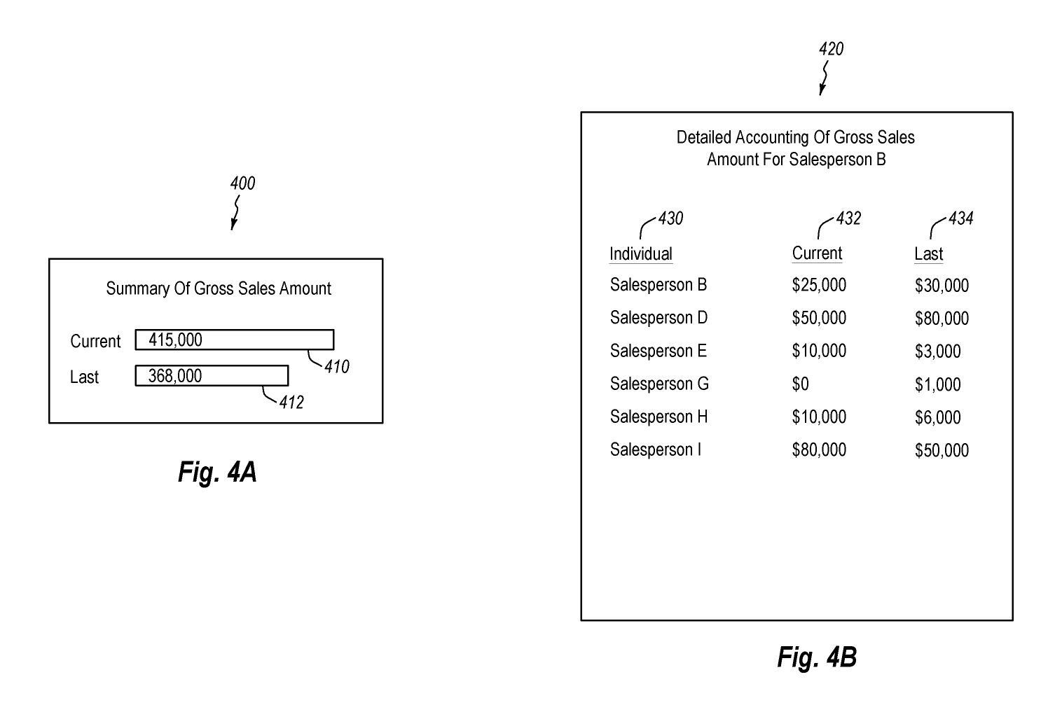

As an example of a query result, FIG. 4A depicts the results of a query requesting the MLM's gross sales amounts for the current and previous time periods, as if the query was run by salesperson B. In the depicted implementation, the summarized information 400 is displayed as two bar charts 410, 412 that each respectively include labels of $415,000 as the current gross sales and $368,000 of the previous gross sales. One will understand that the depicted values and chart conform to the information 312, 314 stored within the hierarchically organized data 210 of FIG. 3, which includes additional nodes beyond those displayed within the Figure.

As depicted, the summary of the gross sales amount 400 includes information from every entry within the entire hierarchically organized data structure 210. In contrast to the implementation depicted, in at least one implementation, the query processor 105 must access information in a first hierarchically organized data structure 210 that relates to the present time period, and access information in a second hierarchically organized data structure 210 that relates to a previous time period.

When accessing the information within the various entries to create the summarized data 400, the query processor 105 can use information from the permissions module 110 to determine whether the requestor 300 has the appropriate permissions or filter to access the data. If the requestor 300 does not have the appropriate permissions, the query processor 105 can either neglect to include the prohibited information within the summary, stop calculating the summary and notify the requestor 300 of the insufficient permissions, or continue to calculate the summary and notify the user that the data may not be complete due to insufficient permissions. Accordingly, an administrator can control the information that a requestor 300 can access, both on a summary level and on a detailed accounting level.

Returning to the Figures, FIG. 4B depicts a detailed accounting 420 of the information summarized in FIG. 4A. The detailed accounting 420 is depicted as if request by Salesperson B. In at least one implementation, Salesperson B can request a detailed accounting of the summary 400 by clicking on the displayed summarized information 400, by selecting a button specific to a detailed accounting, by rerunning a search with an option specifying a detailed accounting, or by some other method of specifying between a summary of information 400 and a detailed accounting 420 of the information.

Further, in at least one implementation, when the query processor 105 creates a summary 400, at least a portion of the information that was used in the creating the summary is cached, such that if a detailed accounting 420 is requested, no additional search must be performed. In contrast, in at least one implementation, the query processor 105 runs a separate search for both the summary of the information 400 and the detailed accounting 420 of the information. In any case, all necessary permissions (i.e., filters) are checked to ensure that the requestor 300 is only able to access appropriate summary information 400 and detailed accounting information 420.

In the example depicted in FIGS. 4A, Salesperson B has accessed summary data (i.e., cumulative anonymous data) regarding gross sales from every entry within the hierarchically organized data structure 210. When attempting to access detailed accounting of the summarized information, as depicted in FIG. 4B, the query processor 105 receives from the permission module 110 a second permission (i.e., second filter) that the query processor 105 applies when generating the detailed accounting 420 of the information.

For example, in FIG. 4B, the query processor 105 receives a query from Salesperson B requesting a detailed accounting of the gross sales. The permission module 110 then provides a second filter that restricts Salesperson B to only accessing a detailed accounting of the gross sales of individuals within Salesperson B's downline. In particular, the second filter allows Salesperson B to accesses, from within his or her own downline, detailed accounting 420 information that includes the individual's names 430, each individual's current gross sales 432, and each individuals previous gross sales 434. As such, the gross sales numbers from FIG. 4B do not sum to the gross sales numbers in FIG. 4A in this case because, when generating a summary, Salesperson B has permissions necessary to access the entire MLM data structure. In contrast, when generating a detailed accounting, Salesperson B only has access to a portion of his or her own downline.

In at least one implementation, the first filter and the second filter can be concurrently applied to sequential entries within the ordered flat file 106. For example, when responding to a query, the query processor 105 can access a starting point of interest within the ordered flat file 106 and then apply both the first filter and the second filter to each sequential entry within the ordered flat file 106 until the necessary data for answering the query is gathered.

In an exemplary case, the first filter can allow the query processor 105 to gather summary information relating to every individual stored within the ordered flat file 106. For instance, the first filter may allow the query processor 105 to track a summation of total sales from every individual within the queries range, but not to track how the total sales associate with each individual. In contrast, the second filter may allow the query processor 105 to gather specific data about individuals who are just within the requestor's downline. As such, the query processor 105 can apply both filters to each sequential entry within the ordered flat file 106. The ability to concurrently apply multiple filters to hierarchically-organized data can provide significant computation benefits, in particular, when the multiple filters can be quickly and efficiently applied to sequentially-linked, hierarchically-organized data.

Salesperson B can rely upon the detailed accounting 420 depicted in FIG. 4B to identify patterns within his or her own downline. In some situations, Salesperson B has a relationship with at least a portion of the individuals in his or her downline, and Salesperson B may also be compensated based upon the performance of individuals in the downline. Accordingly, Salesperson B can rely upon the information provided in the detailed accounting 420 to identify particular individuals whose performance is lacking, or, in contrast, the performance of individuals that is on an upward trend.

In some situations, a company may desire to prevent Salesperson B from contacting other individuals within the hierarchically organized data structure 210 that are not within Salesperson B's own downline. As such, the present invention provides a method, system, and computer application for providing a hierarchically organized data structure 210 that a user can search for a summary and for a detailed accounting, while applying permissions to the searches that are sensitive to the requestor's 300 position with the hierarchically organized data structure 210.

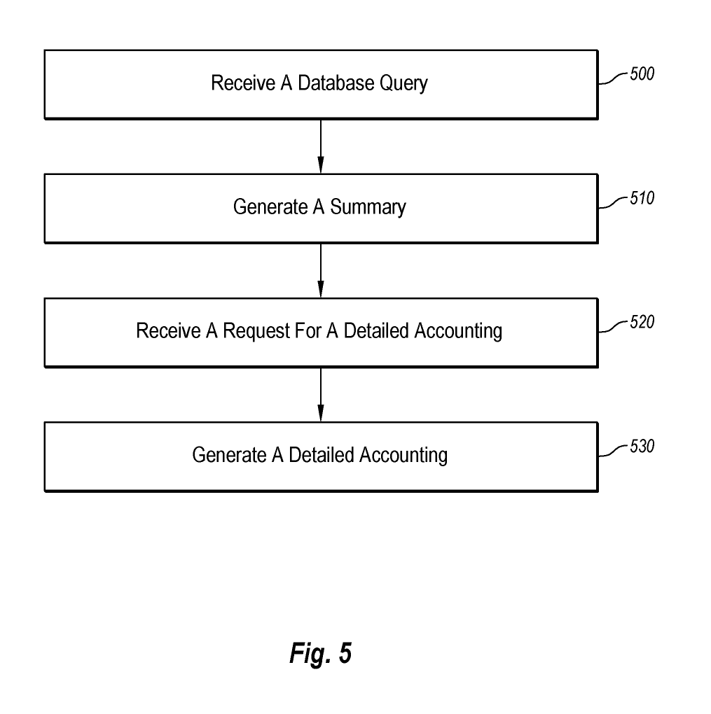

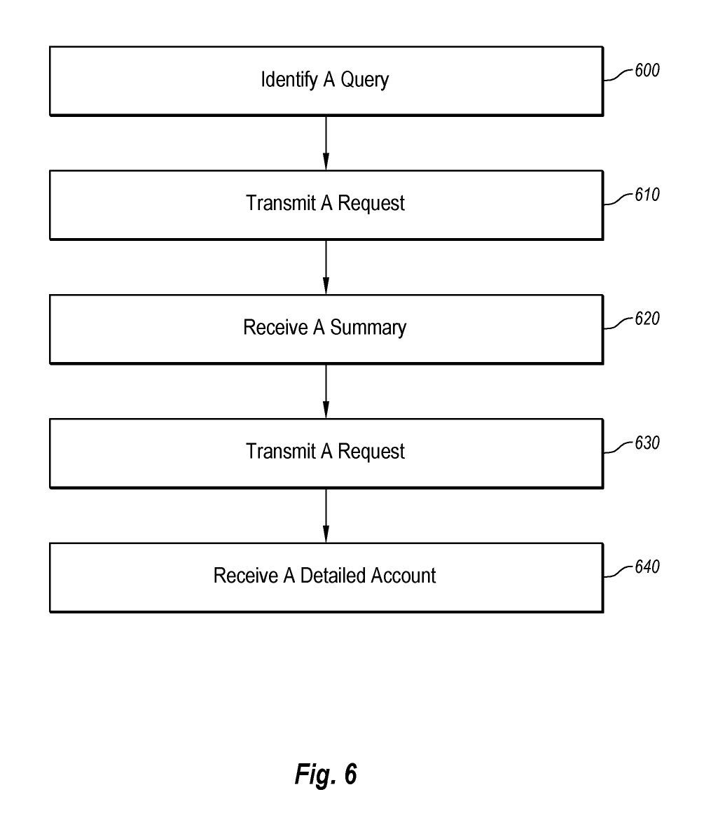

Accordingly, FIGS. 1-4B and the corresponding text illustrate or otherwise describe one or more methods, systems, and/or instructions stored on a storage medium for accessing hierarchically organized elements maintained in a database. One will appreciate that implementations of the present invention can also be described in terms of methods comprising one or more acts for accomplishing a particular result. For example, FIGS. 5 and 6 and the corresponding text illustrate flowcharts of a sequence of acts in a method for accessing hierarchically organized elements maintained in a database. The acts of FIGS. 5 and 6 are described below with reference to the components and modules illustrated in FIGS. 1-4B.

For example, FIG. 5 illustrates that a flow chart for an implementation of a method for multi-level data resolution based upon searches of the hierarchically organized elements in a database can comprise an act 500 of receiving a database query. Act 500 includes receiving a database query directed towards returning information from one or more locations within a hierarchically organized data structure. For example, FIG. 1 and the accompanying description, illustrates that query 103 is directed towards returning information that is stored within the ordered flat file 106.

FIG. 5 also shows that the method can comprise an act 510 of generating a summary. Act 510 includes generating a summary of the information that conforms with the query and a first filter condition. For example, in FIG. 4A and the accompanying description, the system generates a summary 400, in the form of bar charts that summarizes the gross sales amount for the entire MLM, or at least a portion of the MLM, during the current and previous time periods. In particular, the generated summary conforms with a first filter that allowed the query to return cumulative information generated within the hierarchically organized data structure 210, while preventing the query from accessing detailed information from at least a portion of the entries within the hierarchically organized data 210.

Additionally, FIG. 5 shows that the method can include an act 520 of receiving a request for a detailed accounting. Act 520 includes receiving a request for a detailed view of the information in the summary. For example, FIGS. 4A and 4B and the accompanying descriptions describe receiving an indication to provide a detailed accounting 420 of the summary information 400. For example, in at least one implementation, when a requestor 300 clicks on the summary chart 400, a detailed accounting 420 of the summary information 400 is automatically generated.

FIG. 5 also shows that the method can include an act 530 of generating a detailed accounting. Act 530 includes generating a detailed accounting of the information that conforms with the query and a second filter condition. The second filter condition can be different from the first filter condition. For example, in FIG. 4B and the accompanying description, salesperson B initiates a query 103 directed towards returning a detailed accounting of the information summarize in FIG. 4A. In response to the query 103, the query processor 105 receives a second filter from the permissions module 110. The second filter can be configured to prohibit Salesperson B from accessing detailed accounting information from any entry outside of Salesperson B's own downline and/or from a specific subset of entries within Salesperson B's downline. Accordingly, the detailed accounting 420 depicted in FIG. 4B comprises only information relating to permitted entries in Salesperson B's downline.

As an example of an additional implementation, FIG. 6 illustrates that a flow chart for an implementation of a method for multi-level data resolution based upon searches of the hierarchically organized elements can comprise an act 600 of identifying a database query. Act 600 includes identifying a query of interest that is directed towards returning a summary of information gathered from multiple entries within a hierarchically organized data structure. For example, in FIGS. 1 and 4A and the accompanying description, user application 102 identifies query 103, which is directed to returning a summary of gross sales stored within the hierarchically organized data 210, as depicted in FIG. 2.

FIG. 6 also shows that the method can comprise an act 610 of transmitting a request. Act 610 includes transmitting the query of interest to a database system. For example, in FIG. 1 and the accompanying description, query 103 is transmitted from the user application 102 to the database system residing within server 104. In at least one implementation, however, user application 102 and the database system can be located within the same computing system.

Additionally, FIG. 6 shows that the method can include an act 620 of receiving a summary. Act 620 includes receiving a summary of the information that conforms with the query of interest. For example, FIG. 4A and the accompanying descriptions describe receiving the requested information summary 400. In particular, FIG. 4A depicts an information summary 400 that is responsive to the query for returning a summary of gross sales stored within the hierarchically organized data 210.

FIG. 6 also shows that the method can include an act 630 of transmitting. Act 630 includes transmitting a request for a detailed accounting of at least a portion of the information in the summary. For example, in FIG. 4B and the accompanying description, salesperson B initiates a query 103 directed towards returning a detailed accounting of the information summarize in FIG. 4A.

Further FIG. 6 shows that the method can include an act 640 of receiving a detailed accounting. Act 640 includes receiving a detailed accounting of at least the portion of the information that conforms with the query of interest. For example, FIG. 4B depicts a detailed accounting 420 that comprises only information relating to entries in Salesperson B's downline.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud computing model can be composed of various characteristics, such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A computer system for accessing hierarchically organized elements maintained in a database, a computerized method for resolving multi-level data based upon searches of the hierarchically organized elements, comprising:
one or more processors; and
one or more computer-readable media having stored thereon executable instructions that when executed by the one or more processor configure the computer system to perform at least the following:
receive a database query directed towards returning information from one or more locations within a hierarchically organized data structure;
generate a summary of the information that conforms with the query and a first filter condition;
receive a request for a detailed view of the information in the summary; and
generate a detailed accounting of the information that conforms with the query and a second filter condition, wherein the second filter condition is different from the first filter condition.

2. The system as recited in claim 1, wherein the executable instructions include instructions that when executed configure the computer system to:
after receiving the database query, access an ordered flat file database;
wherein the ordered flat file database comprises the information stored within the hierarchically organized data structure, including information associating each entry within the ordered flat file database with the entry's relative position within the hierarchically organized data structure.

3. The system as recited in claim 2, wherein:
each entry within a particular branch of the hierarchically organized data structure comprises a particular corresponding data field; and
the summary of the information comprises a sum of all the particular corresponding data fields within each entry within the particular branch.

4. The system as recited in claim 3, wherein the detailed accounting of the information comprises an individual listing of each of the particular corresponding data fields within each entry within the particular branch.

5. The system as recited in claim 1, wherein the second filter condition prevents information included within the summary of the information from being accessed.

6. The system as recited in claim 1, wherein the summary of the information provides an overview of the information within the detailed accounting of the information.

7. The system as recited in claim 1, wherein the executable instructions include instructions that when executed configure the computer system to create a graph that communicates the summary of the information.

8. The system as recited in claim 7, wherein the summary of the information comprises more than one graph comparing information from different periods of time.

9. The system as recited in claim 7, wherein the summary of the information comprises more than one graph respectively depicting individual summaries of portions of the summary of the information.

10. The system as recited in claim 1, wherein the summary of the information comprises multiple summaries of multiple independent data points.

11. The system as recited in claim 1, wherein the executable instructions include instructions that when executed configure the computer system to create a table that communicates the detailed accounting of the information.

12. A computer system for multi-level data resolution based upon searches of the hierarchically organized elements, comprising:
one or more processors; and
one or more computer-readable media having stored thereon executable instructions that when executed by the one or more processors configure the computer system to perform at least the following:
identify a query of interest, wherein the query of interest is directed towards returning a summary of information gathered from multiple entries within a hierarchically organized data structure;
transmit the query of interest to a database system;
receiving a summary of the information that conforms with the query of interest;
transmit a request for a detailed accounting of at least a portion of the information in the summary; and
receive a detailed accounting of at least the portion of the information that conforms with the query of interest.

13. The system as recited in claim 12, wherein the database system comprises the hierarchically organized data structure stored within an ordered flat file that comprises:
information stored within the hierarchically organized data structure; and
information associating each entry within the ordered flat file database with the entry's relative position within the hierarchically organized data structure.

14. The system as recited in claim 12, wherein the summary of the information provides an overview of the information within the detailed accounting of at least the portion of the information.

15. The system as recited in claim 12, further comprising receiving one or more graphs that depict different subsets of the summary of the information.

16. The system as recited in claim 15, wherein the at least the portion of the information comprises a detailed accounting of one of the different subsets of the summary information.

17. The system as recited in claim 16, wherein the executable instructions include instructions that when executed configure the computer system to receive an indication from a user to display a detailed accounting of a particular subset of the summary information.

18. The system as recited in claim 12, wherein the executable instructions include instructions that when executed configure the computer system to receive a table that communicates the detailed accounting of at least the portion of the information.

19. The system as recited in claim 12, wherein the query of interest is directed towards returning an accumulation of information stored within one or more branches of the hierarchically organized data structure.

20. A method, implemented at a computer system that includes one or more processors, for multi-level data resolution based upon searches of the hierarchically organized elements, the method comprising:
receiving a database query directed towards returning information from one or more locations within a hierarchically organized data structure;
generating a summary of the information that conforms with the query and a first filter condition;
receiving a request for a detailed view of the information in the summary; and
generating a detailed accounting of the information that conforms with the query and a second filter condition, wherein the second filter condition is different from the first filter condition.
